(19) United States
(12) Patent Application Publication
(10) Pub. No.: US 2018/0202798 A1
(43) Pub. Date: Jul. 19, 2018

(54) VISUAL POSITIONING INSPECTION CELL AND METHOD

(71) Applicant: TECNATOM, S.A., Madrid (ES)

(72) Inventor: Sebastián Hernández Serrano, Madrid (ES)

(21) Appl. No.: 15/843,248

(22) Filed: Dec. 15, 2017

(30) Foreign Application Priority Data
Jan. 13, 2017 (ES) P201730034

(51) Int. Cl. G01B 11/14; H04N 5/247

(52) U.S. Cl. CPC G01B 11/14; H04N 5/247

(57) ABSTRACT

A visual positioning inspection cell for inspection of parts includes an inspection subsystem with sensors, and a positioning subsystem of the sensors with at least three cameras. Both systems are synchronized with each other by means of an indexing transmitted through a hardware line, for example accompanied by a timestamp. This allows more parts to be inspected or the position of more sensors to be detected. The visual positioning inspection method for inspection of parts associates the reading of each sensor with its position by an indexing between the positioning subsystem and the inspection subsystem including the sensors through the hardware line, interpolating, if necessary, the position of the sensors by means of a timestamp.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### Field of the Invention

The present invention relates to a visual positioning inspection cell for non-destructive inspection, e. g. by means of ultrasounds and/or eddy currents, which enables a series of parts to be analyzed and checked in parallel by means of one or more posts, with one or more sensors.

It also refers to a method used therefor.

### Description of Related Art Including Information Disclosed Under 37 CFR 1.97 and 37 CFR 1.98.

Patent ES2411811 relating to an ultrasonic inspection system is known in the state of the art. This system comprises a set of cameras that detect the position of a single mobile device with a single sensor to identify its position relative to the part to be inspected. To do this, the sensor has markers that allow the processor to recognize its position and orientation.

This system is effective, but limited. Its internal organization comprises two subsystems, one for location and one for inspection, which have to work in parallel and in real time to allow matching the position data with the inspection carried out. In this way, the position and reading of the sensor must be taken in real time and coordinated by a data acquisition subsystem, without the possibility of coordination and cooperation between the two subsystems.

### BRIEF SUMMARY OF THE INVENTION

The invention relates to a visual positioning inspection cell and method according to the claims, in particular according to claim 1.

The parts inspection cell is similar to the aforementioned Spanish patent in that it has an inspection subsystem, with at least one sensor, and a positioning subsystem consisting of at least three cameras that detect the position of each sensor, being the subsystems communicated with a processing system. However, the main difference is that the images or frames generated by the positioning subsystem and the data captured by each triggering of the inspection subsystem are indexed by a direct connection (hardware) between them, so that they are coordinated in the processing system, releasing these systems to be able to handle and position more sensors. An additional timestamp in each trigger and frame allows for a spatial interpolation within the same index in order to improve the accuracy of the position information.

Therefore, preferably and in order to take full advantage of the invention, the cell has at least two sensors, which may correspond to ultrasonic sensors, thermographic sensors and eddy current sensors. Other sensors can be gauges or other non-destructive forms of inspection.

On the other hand, to avoid having to move parts, which are sometimes heavy and bulky (e. g. aircraft components such as wings), the cameras can be mounted on a portable or detachable structure such as tripods or gantries. If the parts are small or easily movable, the cell can be fixed.

In turn, the part inspection method involves moving one or more sensors along the part to be inspected and associating the reading of each sensor with its position detected by a positioning subsystem comprising at least three cameras, as in the prior art. In a novel way, the association of the sensor reading with its position is carried out by a direct synchronization between the positioning subsystem and the inspection subsystem comprising the sensors. That synchronization is a direct connection (hardware) between the two of them, optionally completed by a timestamp.

Two or more parts can be inspected, which can be recognized by the positioning subsystem (either by codes or by shapes stored in the memory).

As indicated above, the cameras may be mounted on a fixed or portable structure (e. g. detachable). This would require assembly and calibration of the cameras prior to inspection.

### BRIEF DESCRIPTION OF THE SEVERAL VIEWS OF THE DRAWINGS

For a better understanding of the invention, the following figures are included.

FIG. 1 is a schematic perspective view of a first exemplary embodiment.

FIG. 2 is an example of the cell implantation scheme in a second exemplary embodiment.

### DETAILED DESCRIPTION OF THE INVENTION

The following is a brief description of an embodiment of the invention, as an illustrative and non-limiting example thereof

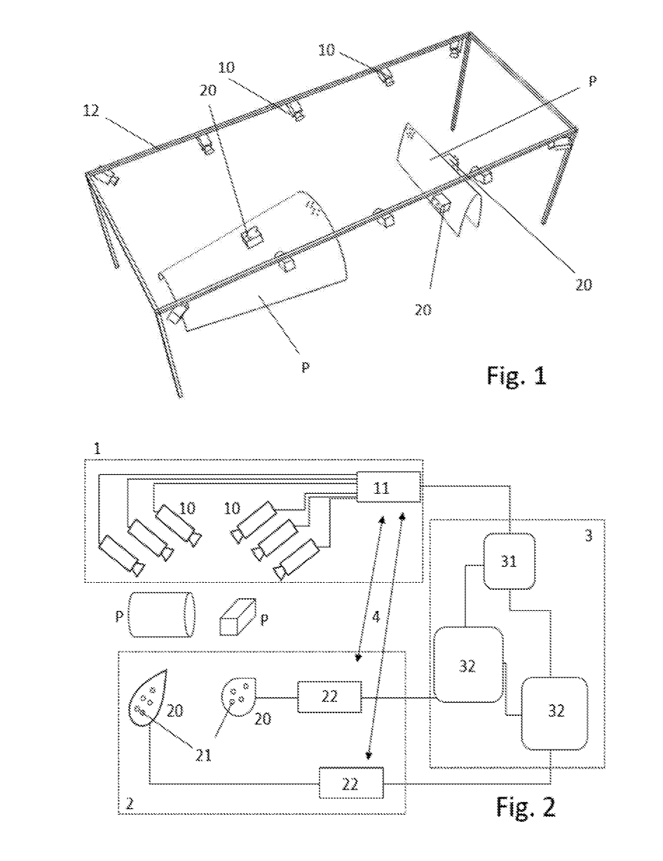

The schematic embodiment shown in FIG. 1 comprises a positioning subsystem (1) consisting of a series of cameras (10), at least three, but preferably at least six cameras. It also comprises an inspection subsystem (2), consisting of a series of sensors (20) with markers (21) forming a pattern recognizable by the positioning subsystem (1). Generally, these sensors (20) are part of an ultrasonic equipment, so that they emit ultrasonic waves and receive the reflected response from the internal surfaces of the part (P) to be inspected. They may also correspond to eddy current sensors or other types of testing, preferably non-destructive. Finally, the cell comprises a processing system (3) for the information collected by the subsystems (1, 2).

In contrast to the state of the art, the communication between the two subsystems (1, 2) is direct through a hardware line (4). Thanks to the hardware line (4), the positioning subsystem (1) and the inspection subsystem (2) synchronize with each other and index the images (frames) and the triggers of the sensors (20), also transmitting a timestamp between the corresponding controllers (11, 22).The indexing allows the position of each sensor (20) to be synchronized with its readings for further processing, while the timestamp allows any indexing misalignment to be corrected by interpolating the position of the sensors (20) at the time of triggering.

As the positioning subsystem (1) does not require any data processing, it is possible to derive resources to follow the position of several different sensors (20) so that parallel checks can be carried out. The positioning subsystem (1) will recognize each sensor (20) by the drawing of its markers (21). These sensors (20) can also inspect different parts (P), increasing the cell capacity.

An advantageous way of applying the invention is to divide the inspection subsystem (2) into several independent units with their own sensors (20). Thus, each unit of the inspection subsystem (2) can perform a different type of testing: ultrasounds, eddy currents, etc., so that different checks are carried out in parallel.

The cell can be transportable, by making the cameras (10) integrated into a portable or detachable structure (12). For example, the cameras (10) may be installed on a series of tripods or on a series of gantries joined together. In this case, the first operation of the cell should be calibration to correct any relative movement between the cameras (10).

The embodiment shown in the scheme of FIG. 2 comprises a processing system (3) divided into a primary processing (31) and a secondary processing (32). The primary processing (31) receives the information from the positioning subsystem (1), with its indexing and eventual timestamp, and sends it to the secondary processing (32) that carries out the joint processing with the data captured by the inspection subsystem (2) to show them to an operator and mark any eventual defects. The number of secondary processings (32) will depend on the workload generated by the sensors (20). For example, the processing of data captured by an ultrasonic sensor (20) requires more processing capacity than the readings of an eddy current sensor (20).

The hardware line (4) is arranged between the controller of the positioning subsystem (11) and the different controllers (22) of the sensors (20).

The cameras (10) of the positioning subsystem (1) may in turn detect the (static) parts (P) to be inspected, so that the cell recognizes them with respect to the parts (P) stored in its memory, as well as their position and orientation. In this way, the positioning subsystem (1) will not only be able to know the position and orientation in the space of the sensors (20), but can also associate that position with the position relative to the part (P) to be inspected. The parts (P) may also have an identification code that can be read by the cameras (10) and their own orientation markers.

Therefore, the method carried out in the cell involves having one or more parts (P) in a working area, surrounded by at least three cameras (10) of a positioning subsystem (1). The identity of each part (P) is entered into the controller of the cell assembly, which can be a secondary processing (32) and the inspection is carried out with one or more sensors (20) that have markers (21) for the detection and location thereofby the positioning subsystem (1). The sensor (20) readings coming from their triggers, and the frames, which allow the positioning subsystem (1) to recognize the position, are sent with synchronization by indexing through a specific hardware line (4), generally accompanied by a timestamp, to a processing system (3).

I claim:

1. A visual positioning inspection cell, for inspection of parts, with an inspection subsystem, with at least one sensor and a positioning subsystem comprising of at least three cameras that detect the position of each sensor, being the subsystems communicated with a processing system characterized in that the frames of the positioning subsystem and the triggers of the sensors of the inspection subsystem are synchronized by an indexing transmitted through a hardware line arranged between both subsystems.

2. The cell, according to claim 1, wherein the synchronization also includes a timestamp.

3. The cell, according to claim 1 comprising as at least two sensors.

4. The cell, according to claim 3, wherein the sensors are divided into ultrasonic sensors and eddy current sensors.

5. The cell, according to claim 1, wherein the cameras are mounted on a portable or detachable structure.

6. The cell according to claim 1, wherein the cameras are mounted on a fixed structure.

7. A visual positioning inspection method for inspection of parts, conducted by the cell of claim 1, which includes moving one or more sensors along the part or parts to be inspected and associating the reading of each sensor to its position detected by a positioning subsystem comprising at least three cameras, characterized in that the association of the reading of the sensor with its position is carried out by an indexing of the frames of the positioning subsystem and of the triggers of the sensors of the inspection subsystem comprising the sensors by means of a hardware line.

8. The method, according to claim 7, wherein the synchronization also includes a timestamp and, if the timestamps of a frame do not correspond with the triggers of the sensors, the same method performs the interpolation of the position of the sensors.

9. The method, according to claim 7, wherein the inspection of two or more parts is carried out in parallel.

10. The method, according to claim 7, wherein the inspection is performed by means of two or more sensors.

11. The method, according to claim 7, wherein the part or parts to be inspected are recognized by through the positioning subsystem.

12. The method, according to claim 7, comprising a previous stage of assembly of a portable structure carrying the cameras and calibration of the positioning subsystem.
